(19) United States
(12) Patent Application Publication
(10) Pub. No.: US 2024/0227318 A1
(43) Pub. Date: Jul. 11, 2024

(54) Automatic welding machine and method for thermal joining of material sheets

(71) Applicant: Leister Technologies AG, Kägiswil (CH)

(72) Inventors: Roger Bürgler, Ennetbürgen (CH); Andreas Scheuber, Sarnen (CH); Roland Beeler, Zug (CH)

(21) Appl. No.: 18/408,264

(22) Filed: Jan. 9, 2024

(30) Foreign Application Priority Data
Jan. 9, 2023 (DE) 10 2023 100 325.9

(51) Int. Cl. B29C 65/00

(52) U.S. Cl. CPC B29C 66/9241; B29C 66/1122; B29C 66/435; B29C 66/83411

(57) ABSTRACT

An automatic welding machine for thermally joining sheets of material, in particular for edge-side joining of an overlapping upper material sheet to a lower material sheet, to be connected to one another in a materially bonded manner under the effect of heat and subsequent application of pressure, is provided comprising: a heating device for at least partially heating the material sheets to be joined in a connection region; a chassis comprising a pressure roller, configured to apply pressure to the material sheets in the working direction behind the heating device; a mount for one or more additional weights configured to increase a pressure on the pressure roller; and a weight sensor for measuring a weight force caused inter alia by the one or more additional weights in the mount, which acts at least partially on the pressure roller. Further a corresponding method is provided.

### CROSS-REFERENCE TO RELATED APPLICATIONS

This application claims the priority of German patent application No. 10 2023 100 325.9, filed Jan. 9, 2023, which is incorporated herein by reference in its entirety.

The present invention relates to an automatic welding machine for thermal joining material sheets/webs, and also relates to a corresponding method for thermal joining material sheets.

### BACKGROUND

Automatic welding machines for thermal joining material sheets are generally known from the state of the art. Such automatic welding machines are used, for example, for thermally joining or welding thermoplastic material sheets, such as plastic films or plastic or bitumen sheets, along their overlapping edge regions. In addition to a drive and at least one hot air unit or a heating wedge device, such automatic welding machines comprise a chassis comprising one or more drive rollers, pressure rollers and/or support rollers or a combination thereof. During the automatic welding process, the automatic welding machine moves over an essentially flat surface on which the materials to be welded are joined by the automatic welding machine. In case of hot air welding, at least one hot air nozzle, which is arranged at the hot air outlet of a hot air unit of the automatic welding machine, is guided into a welding region of the materials to be welded between the overlapping edge regions of the materials in order to plasticize the materials in the welding region by applying heat. Afterwards the plasticized regions of the materials are pressed together and a materially bonded connection is formed, for example by a pressure roller arranged downstream of the hot air nozzle in the working direction or direction of movement of the automatic welding machine.

Generally two different types of automatic welding machines are known for thermal joining of material sheets. The first type are close-to-ground or ground-level automatic welding machines, the second type are automatic welding machines with counter rollers.

So-called ground-level automatic welding machines press on the melted overlap area of the material sheets placed on a (solid) ground on one side with a pressure roller. The pressure acting on the joining region therefore depends on the own weight of the automatic welding machine and any additional weights. An exemplary ground-level automatic welding machine is the product Leister Varimat V2 of the present applicant Leister Technologies AG, Kaegiswil, Switzerland.

EP 3 028 836 B1 describes an exemplary ground-level automatic welding machine. EP 3 028 836 B1 discloses an automatic welding machine for edge-side connection at the edge of sheets overlapping material webs, wherein the materials are connectable to one another under the effect of heat and subsequent pressure, with a chassis on which at least guide rollers, a heating device and at least one pressure roller are arranged. The heating device has a cantilevered contact heating element that can be inserted laterally between the edges of the material webs, wherein the chassis is driven by an electric motor which is arranged on a longitudinal leg of the chassis. The electric motor according to the invention is formed as a brushless DC motor and the reduction gear as a planetary gear, which are united by a drum drive motor. In this case, the DC motor is preferably a disk rotor motor.

The chassis in EP 3 028 836 B1 has a lateral or transverse leg which is adjustable perpendicular to the working direction relative to the longitudinal leg. The entire transverse leg with the non-driven guide rollers can thus be displaced laterally relative to the longitudinal leg, on which the heating device and the control unit of the automatic welding machine are arranged and to which the drum driving motor carrying the drive roller is fixed. The shape of the chassis can thus be changed, namely from a first L-shaped structural variant, wherein the lateral leg only protrudes in the working direction only on the left side of the longitudinal leg, via T-shaped structural variants, rein the lateral leg protrudes in the working direction to the left and right of the longitudinal leg, to a second L-shaped structural variant, wherein the lateral leg only protrudes in the working direction to the right of the longitudinal leg. This advantageously facilitates near-edge welding along upwards or downwards sloping surfaces supporting the materials webs, i.e. for example upwardly extending walls, doors, manholes or parapet edges and front edges of flat roofs.

An advantage of the ground-level automatic welding machines is their ease of handling and material guidance.

In addition to the so-called ground-level automatic welding machines, automatic welding machines with counter rollers are also known. Such welding machines are mainly used in civil engineering, e.g. in the areas of landfill sealing, tunnel sealing, etc. In automatic welding machines with counter rollers, the material sheets to be joined are guided between two counter rollers, an upper pressure roller above the two material sheets to be welded and a lower pressure roller below the material sheets to be welded. The pressure acting on the material sheets to be joined can be adjusted by a distance between the counter rollers or a tensioning force between the counter rollers. A clamping lever is provided for this purpose. An exemplary ground-level automatic welding machine is the product Leister Comet by the present applicant Leister Technologies AG, Kaegiswil, Switzerland.

DE 20 2017 104 745 U1 describes an exemplary automatic welding machine with counter rollers. DE 20 2017 104 745U1 discloses an automatic welding machine for welding planar, thermoplastic materials which, during the welding process, exerts a pressure on the materials to be welded in the area of the weld by at least one pressure device and thus exerts a joining force on the materials to be welded, wherein the pressure device comprises at least one clamping lever, a pressure means and a device for limiting the joining force in the form of a length-adjustable pendulum support, wherein the pendulum support comprises at least one spring element and a stop which limits the maximum length of the pendulum support such that the joining force is limited in a defined manner. In other words, a spring element is provided which limits the clamping force acting between the counter rollers.

An advantage of automatic welding machines with counter rollers is that a well-defined clamping force can be set between the counter rollers with a clamping lever. In particular, operating errors caused by excessively high clamping forces can be avoided.

### SUMMARY

Against this background, it is an objection of the present disclosure to provide a further improved automatic welding machine for thermally joining material sheets. In particular, it would be desirable to provide an automatic welding machine with simple handling, which makes it easier for an operator to achieve the best possible welding result.

According to a first aspect of the present disclosure, an automatic welding machine for thermally joining material sheets, in particular for edge-side joining of an overlapping upper material sheet to a lower material sheet, to be connected to one another in a materially bonded (substance-to-substance bonding) manner under the application of heat and subsequent application of pressure, is provided, comprising: a heating device for at least partially heating the material sheets to be connected in a connection region; a chassis comprising a pressure roller configured to apply pressure to the material sheets in the working direction behind the heating device; a mount for one or more additional weights (add-on weights) configured to increase a pressure on the pressure roller; and a weight sensor for measuring a weight force caused (inter alia) by the one or more additional weights in the mount, which acts at least partially on the pressure roller.

According to a further aspect of the present disclosure, a method for thermally joining material sheets, in particular for edge-side joining of an overlapping upper material sheet to a lower material sheet, to be connected to one another in a materially bonded manner under the application of heat and subsequent application of pressure, is proposed, comprising the steps of: providing an automatic welding machine as described in the context of the present disclosure; applying one or more additional weights, which are configured to increase a pressure on the pressure roller, in the mount of the automatic welding machine; and measuring a weight force caused (inter alia) by the one or more additional weights, which acts at least partially on the pressure roller. The measured weight force can optionally be displayed on a display device, stored for documentation purpose or used for adjusting one or more welding parameters.

The contact pressure with which the material sheets to be connected to one other are pressed together is a decisive welding parameter. Depending on the welding material used, weld seam width, welding speed and nozzle type of a hot air nozzle or type of heating wedge, a different contact pressure may have to be set. If the contact pressure is too low, this can lead to an incomplete weld; if the contact pressure is too high, this can force the melt sideways, resulting in a weld seam with reduced strength. The pressure acting on the pressure roller is composed of the own weight of the automatic welding machine without additional weights and the additional weight force caused by one or more additional weights acting on the pressure roller. For inexperienced users, however, it can happen that not the appropriate additional weight is used for a given welding task. There is also a risk of incorrect operation in that a welding process is already started even though the required additional weight has not yet been mounted. To make it easier to carry, the welding machine and additional weights are often brought separately to the operation site by the operator. The additional weights are therefore often only fitted directly at the place of use.

Such application errors can be reduced by using automatic welding machines with counter rollers, in which a clamping force can be set in advance. For the welding task, however, the two material sheets to be welded must be guided between two counter rollers in such a way. Handling and material guidance is therefore more complicated than with so-called floor- or ground-level automatic welding machines. Further, there are also applications in which only a narrow upper material sheet is to be applied to a planar lower material sheet. Depending on the application, it is therefore not possible to guide a counter roller underneath the lower material sheet.

However, in many applications it is not necessary to determine a clamping force between two counter rollers.

Instead, a basic idea according to an aspect of the present invention is to provide an automatic welding machine for thermally joining material sheets which, in addition to a mount for one or more additional weights, further comprises a weight sensor for measuring a weight force caused (inter alia) by the one or more additional weights in the mount. The weight of the additional weights is passed on from the mount to the chassis with the pressure roller and thus increases the contact pressure between the material sheets to be connected. In addition to the pressure roller, the chassis can comprise one or more guide rollers. Preferably, however, the mount is arranged above the pressure roller such that the additional weight can act as completely as possible on the pressure roller. The automatic welding machine is configured so that the additional weight acts at least partially on the pressure roller during operation.

With the weight sensor it is possible to determine in a simple way whether the additional weight or weights required for a desired welding task are mounted. Based on the weight force measured by the weight sensor with any additional weights, a (theoretical) contact pressure force in the area of the pressure roller can be determined. This can optionally be shown on a display and/or recorded electronically for documentation purposes. The proposed solution can be implemented in a simple, cost-effective way and cover a majority of relevant application scenarios.

Advantages of aspects of the invention can be, in particular, that simple (electronic) measurement and recording of the mounted additional weights is enabled. A further advantage can be that a weight sensor or a mount with a weight sensor can also be retrofitted in existing devices. A modification of a drive unit, of the heating device or even of the material guide is not necessarily required. The automatic welding machine can comprise a controller. A further advantage can be that welding parameters can be stored in the controller depending on the material to be welded and thus the required contact pressure or required additional weights can also be predetermined. A further advantage can be that a material was processed in accordance with the contact pressure specifications, in particular in accordance with specifications specified by the manufacturer.

The weight sensor can be an electronic weight sensor, for example. Such weight sensors are generally known. For example, weight sensors are used in scales. The weight sensor is configured and arranged to directly or indirectly measure a weight force caused by the one or more additional weights in the mount.

During operation, the weight force acts at least partially on the pressure roller. In other words, at least part of the additional weight is passed on to the pressure roller and thus increases the contact pressure between the material sheets to be joined. The automatic welding machine can be a mobile or self-propelled automatic welding machine with a drive device. The heating device can, for example, be a hot air blower with a welding nozzle or a heating wedge.

The weight sensor can be arranged in the mount for the one or more additional weights. The weight sensor can be configured to measure a weight force exerted by the one or more additional weights on the mount. In other words, a weight sensor that measures the weight force between the additional weight(s) and a housing or frame of the automatic welding machine can be installed at or on the automatic welding machine in the mounting region in which the additional weights are mounted. Put simply, the mount can comprise a scale for additional weights. An advantage of this embodiment can be a simple and cost-effective implementation. A further advantage can be that a weight sensor arranged in such a way can also detect additional forces acting on the mount. If, for example, more pressure is manually applied to the mount by the operator, such additional contact pressure can also be recorded and documented.

In a further refinement, the chassis can comprise a mounting plate for the one or more additional weights. The weight sensor can be arranged in the mounting plate. In particular, the mounting plate can be arranged above the pressure roller. An advantage of this embodiment can be a simple and cost-effective implementation. By arranging the mounting plate with the weight sensor above the pressure roller, the additional weight force by the additional weights acts as completely as possible on the pressure roller.

The automatic welding machine can comprise a plurality of additional weights stackable on top of each other on the mount. As the total additional weight can be provided by several additional weights configured to be stacked on top of each other, the total additional weight can be determined by a (single) weight sensor. The additional weights can comprise corresponding or complementary recesses and protrusions on the top and bottom sides. Thereby the additional weights can in particular be configured to be anti-slip stackable. By mounting the additional weights stacked, the total weight of the additional weights is thus measured. Based thereon the total weight of the mounted additional weights can be determined or, with predetermined weights of individual additional weights, the number of additional weights can be determined. A corresponding weight or a number of predefined additional weights can be displayed on a display device. Alternatively or additionally, with a known basic weight of the automatic welding machine without additional weights, the total contact pressure that theoretically presses on the weld seam during operation can be determined. Thereby, additional forces can again also be detected/recorded if, for example, the operator presses manually on the additional weights during welding. A typical additional weight can for example have a mass of 3 kg. As the additional weights can be mounted in stacks, the total weight of the additional weights is measured. Based thereon on the one hand the mounted (total) additional weight and on the other hand the number of mounted (predefined) additional weights can be displayed/recorded. Usually 0-2 additional weights are envisaged.

At least one of the additional weights can comprise a raised contact surface. The additional weight can be configured to contact the weight sensor in the mount by the raised contact surface and to exert a weight force on the weight sensor. In particular, the weight sensor can be arranged recessed in the mount. Accordingly, the additional weight can comprise a corresponding raised contact surface, which is configured to exert a weight force on the weight sensor arranged recessed in the mount. An advantage of this embodiment can be that compatibility with conventional additional weights can be maintained. A measurement is however only taken when one or more additional weights corresponding with the weight sensor are used.

The weight sensor can be configured to measure a weight force between the chassis of the automatic welding machine and ground (on which the automatic welding machine can be positioned during operation). Alternatively or additionally, the weight sensor can, for example, be arranged in a running gear or undercarriage of the automatic welding machine. The automatic welding machine can for example comprise two guide rollers and a pressure roller. The weight sensor can, for example, be arranged between a support frame of a chassis of the automatic welding machine and a receptacle or mount for the pressure roller. However, a pressure roller with an integrated weight sensor can also be provided. Optionally, the pressure roller can comprise an integrated force sensor, which is integrated into an (elastic) contact surface of the pressure roller. An advantage of this embodiment can be that an actual force or an actual pressure between the pressure roller and the welding material can be reliably measured. The integrated force sensor can, for example, be configured as a sensor band, ideally as a co-rotating sensor band that rotates with the pressure roller. For example, the sensor band can be configured to measure a force over the entire circumference of the roller. Optionally, several sensors or sensor areas can be provided across a width of the pressure roller in order to also measure a pressure distribution across the width of the roller. For example, several narrow sensor bands can be distributed across the width of the roller in order to be able to measure the pressure distribution across the width of the roller.

The automatic welding machine can comprise a control unit, wherein the control unit is configured to set a welding parameter based on the measured weight. An advantage of this embodiment can be that the quality of the connection between the two material sheets can be further improved. A further advantage can be that operating errors of the automatic welding machine can be avoided.

The automatic welding machine can comprise a drive. The control unit can be configured to adjust the drive speed of the drive based on the weight force measured by the weight sensor. For example, a larger additional weight with the associated higher contact pressure can allow a higher drive speed. It is to be understood that further parameters, such as a heating power, may also need to be adjusted. The adjustment of further parameters can be effected by the same control unit or another control unit.

The control unit can be configured to adjust the heating power of the heating device based on the weight force measured by the weight sensor. For example, the control unit can be configured to adjust a temperature of a heating wedge or a temperature of a hot air device. The heating device can comprise a hot air blower and the control unit can be configured to adjust an air flow (or air volume flow) based on the weight force measured by the weight sensor.

As already described at the beginning, the automatic welding machine can comprise a display device. The display device can be configured to display an additional weight and/or a weight force of the pressure roller on ground based on the weight force measured by the weight sensor. An advantage of this embodiment can be that a comparison between an actual value and a target value for a welding task can be made in a simple manner. The display device can be an integrated display device that is integrated into the automatic welding machine. However, it can also be a remotely arranged display device. For example, the automatic welding machine can comprise a communication module and the measured values can be displayed via a smartphone or a computer screen. For example, if the weight of the additional weights has been measured, this can either be displayed directly. Alternatively or additionally, the weight force acting on the pressure roller can be calculated based on the measured weight of the additional weight and the known weight of the automatic welding machine without weight, as well as taking into account the weight distribution on the possibly one or more guide rollers and possibly one or more pressure rollers.

In a further refinement, the welding apparatus can be configured to display one or more predefined values, in particular a number, of predefined additional weights based on the weight force measured by the weight sensor. The values of predefined additional weights can, for example, be stored in a control unit. An advantage of this embodiment can be that based on the measured weight force an assignment possible to predefined additional weights is possible. Thereby predefined additional weights can be detected. A further advantage can be that a measurement of the weight force with limited accuracy can be sufficient. For example, a measurement under harsh conditions on a construction site as well as measurements at different inclinations, as can for example occur during roof work.

The automatic welding machine can comprise a control unit configured to detect the presence and/or values of the one or more additional weights in the mount over time, based on the weight force measured by the weight sensor. An advantage of this embodiment can be that it can be reliably verified over the course of work carried out that the welding processes were carried out with the required additional weights in accordance with the manufacturer's specifications. Furthermore, any discrepancies in the measured values can provide an indication at which locations rework may be necessary. Optionally, the measured values over time can be linked with further measured values such as location data, for example in the form of GPS coordinates.

The automatic welding machine can comprise a control unit configured to determine a total weight force, in particular a weight force acting on the pressure roller, based on a known weight of the automatic welding machine without additional weight and further based on the weight force measured by the weight sensor. The corresponding values can be output via a display device and/or recorded over time.

The heating device can comprise an electrically heated welding wedge and/or a hot air blower. The heating device can comprise an application-specific heating or welding wedge adapted to the welding task. In the case of a hot air blower, the heating device can comprise a corresponding application-specific welding nozzle.

The automatic welding machine can comprise a control unit configured to display one or more of (a) a mains voltage, (b) a movement speed, (c) a hot air temperature, (d) a heating wedge temperature, (e) a (rotational) speed of a hot air blower on a display and/or to record it over time. AN advantage of this embodiment is that it also enables quality control and quality assurance for further parameters.

The advantages described in detail above for the first aspect of the invention apply accordingly to the further aspects of the invention.

It is to be understood that the features mentioned above and those yet to be explained below may be used not only in the combination respectively indicated, but also in other combinations or separately, without departing from the scope of the present invention.

### BRIEF DESCRIPTION OF THE DRAWINGS

Exemplary embodiments of aspects of the invention are illustrated in the following drawings and are explained in more detail in the following description.

FIG. 1 shows a perspective schematic illustration of a ground-level automatic welding machine with an additional weight;

FIG. 2 shows a further perspective schematic illustration of the ground-level automatic welding machine of FIG. 1 without additional weight;

FIG. 3 shows an enlarged illustration of region III of FIG. 2;

FIG. 4 shows a perspective illustration of a weight sensor;

FIG. 5 shows a top view of a display device of an automatic welding machine;

FIG. 6 shows a perspective illustration of an automatic welding machine with an additional weight;

FIG. 7 shows perspective illustration of an automatic welding machine with two additional weights;

FIG. 8 shows perspective illustration from diagonally upward of an additional weight;

FIG. 9 shows a perspective illustration of the additional weight of FIG. 8 from diagonally below;

FIG. 10 shows a perspective illustration of an automatic welding machine with a heating device in a rest position;

FIG. 11 shows a front view of the automatic welding machine of FIG. 10 with the heating device in the rest position; and

FIG. 12 shows a flow chart of a method for thermally joining material sheets.

### DETAILED DESCRIPTION

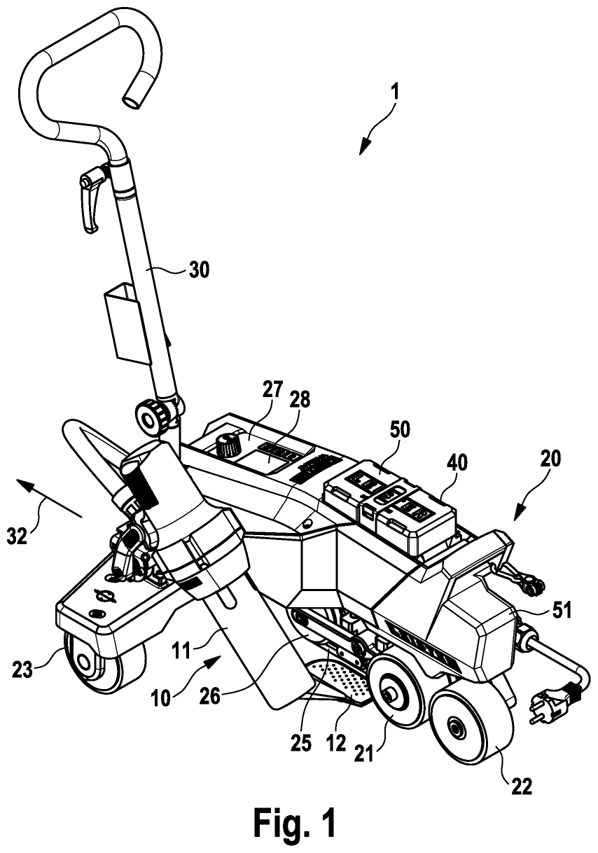

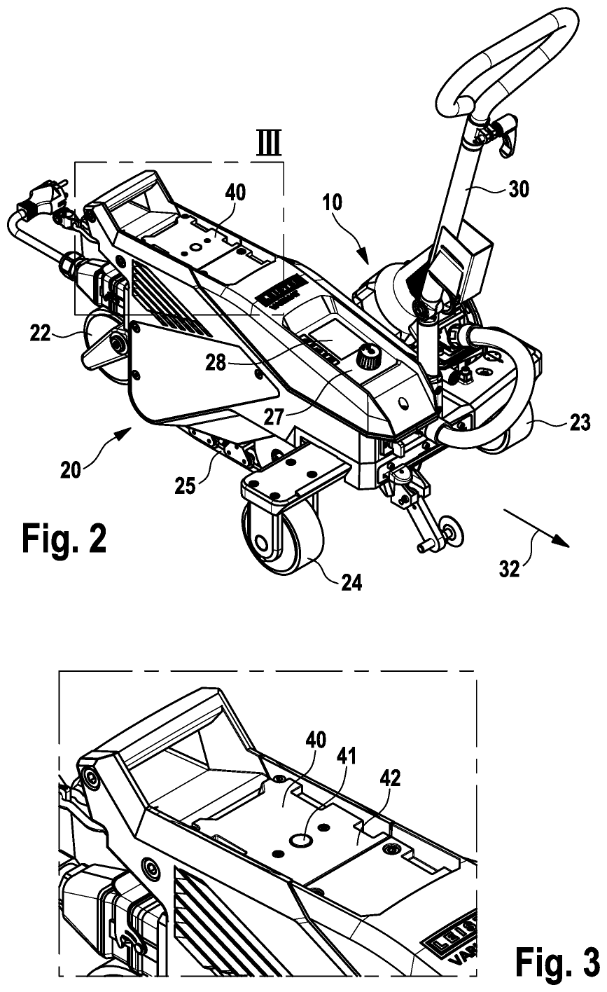

FIG. 1 and FIG. 2 show perspective schematic illustrations of an exemplary automatic welding machine 1 for thermally joining material sheets. The automatic welding machine 1 is configured edge-side joining of an overlapping upper material sheet with a lower material sheet, which can be connected to one another in a materially bonded manner under the application of heat and subsequent application of pressure. The automatic welding machine 1 comprises a heating device 10 and a chassis 20 with a guide rod 30 for guiding the automatic welding machine.

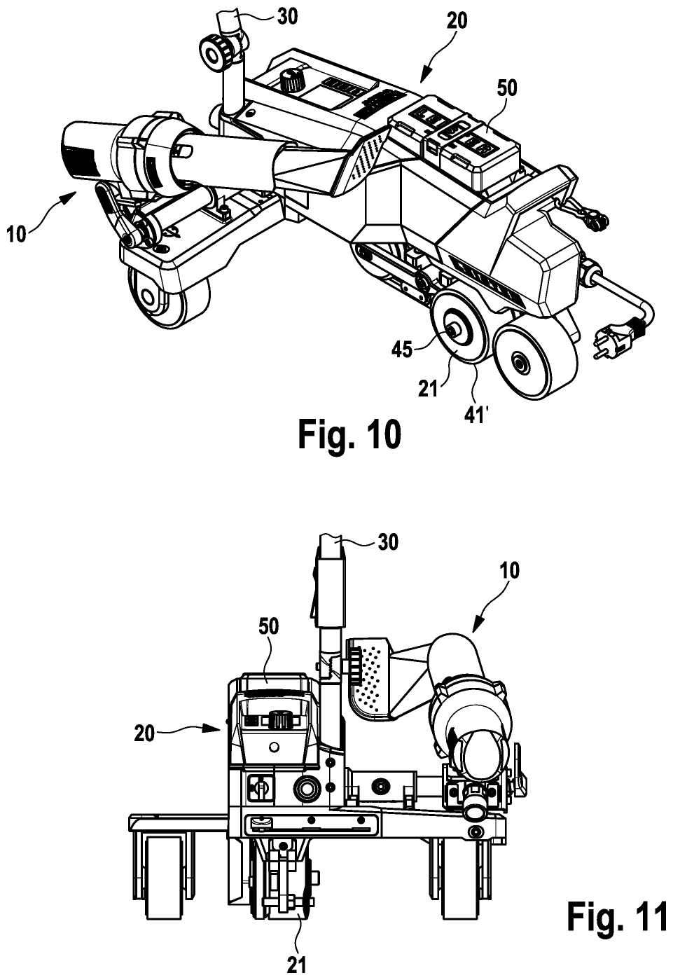

The heating device 10 is configured to at least partially heat the material sheets to be joined in a connection region. In the embodiment shown, the heating device 10 is configured as a hot air blower with a blower body 11 with an internal heating element and a fan for generating an air volume flow and a hot air nozzle 12. In FIG. 1, the heating device 10 is in a working position. In FIGS. 10 and 11, on the other hand, the heating device is in a rest position, preferably extended sideways and tilted upwardly. In the working position, the hot air nozzle is inserted in an overlap region between an upper material sheet and a lower material sheet (not illustrated). Thereby the heating device can heat a bottom side of the upper material sheet and a top side of the lower material sheet and, in particular, at least partially plasticize or melt them. Alternatively, the heating device 10 can be configured as a heating wedge device with an electrically heated heating wedge.

A working direction of the automatic welding machine 1 is illustrated in FIG. 1 and FIG. 2 with an arrow and designated with reference sign 32. The working direction hereby denotes a forward direction in which the automatic welding machine 1 is guided along the overlapping material sheets during operation for edge-side joining. The chassis 20 comprises a pressure roller 21, which is configured to apply pressure to the material sheets in the working direction behind the heating device 10. The pressure roller 21 can at the same time also be configured as a drive roller that automatically drives the automatic welding machine 1. Alternatively, an optional separate drive roller 22 can be provided. However, if the pressure roller 21 also serves as a drive roller, the roller designated with reference sign 22 can also be a follower roller. In the embodiment shown, the chassis further comprises a first guide roller 23 and a second guide roller 24. The guide rollers are arranged at the front in the working direction 32. The first guide roller 23 can therefore be referred to as the left guide roller, and the second guide roller 24 can be referred to as the right guide roller.

In order to further improve the air flow or the heat input between the overlapping material sheets, a pressure belt 25 can optionally be provided. The pressure belt 25 extends, for pressing the edge of an overlapping upper material sheet not shown in the figure against an overlapping lower material sheet, which is also not shown, from between the pressure roller 21 to a preferably tensionable belt guide pulley 26, which is arranged adjacent to or in front of the hot air nozzle in the working direction. The pressure belt 25 can be configured to press the overlapping edge (or rim) of the upper material sheet against the lower material sheet, thus preventing the hot air flow from the hot air nozzle 12 from penetrating under the overlapping upper material sheet. By sealing the overlapping edge at the side, power loss can be reduced and the hot air flow can be guided in the direction against the working direction of the automatic welding machine 1.

As shown in the embodiment illustrated in FIG. 1 and FIG. 2, the automatic welding machine 1 can further comprise a controller 27 (also referred to as control unit) and a display unit 28. In the present embodiment, the controller 27 and the display unit 28 are arranged on a top side of the automatic welding machine. However, it is to be understood that the controller 27 and/or display unit 28 can also be implemented as wireless units which are connected to the automatic welding machine via a communication interface. For example, a smartphone or tablet with corresponding software can be used as a display unit 28 or as an operating interface for a controller. An exemplary illustration of a controller 27 integrated into the automatic welding machine 1 with display unit 28 is shown in the enlarged top view FIG. 5.

The automatic welding machine 1 further comprises a mount 40 for one or more additional weights 50, which are configured to increase a pressure on the pressure roller 21. FIG. 1 shows a perspective view of the automatic welding machine 1 with one additional weight 50. Furthermore, the automatic welding machine 1 can also comprise a permanently installed weight 51, by which a minimum contact pressure without additional weights is defined. On the other hand, FIG. 2 shows a perspective view of the automatic welding machine without additional weight. FIG. 6 and FIG. 7 show perspective illustrations corresponding to FIG. 2 with one additional weight (FIG. 6) and two additional weights (FIG. 7). The mount 40 for the one or more additional weights 50 is arranged on the automatic welding machine 1 and configured so as to increase the pressure on the pressure roller 21 by the additional weights 50 arranged in the mount 40.

FIG. 3 shows an enlarged illustration of region III of FIG. 2. The automatic welding machine 1 further comprises a weight sensor 41 for measuring a weight force caused by the one or more additional weights 50 in the mount 41, which acts at least partially on the pressure roller 21. As shown in FIG. 3, the weight sensor 41 can be arranged in the mount 40 for the one or more additional weights and can be configured to measure a weight force exerted by the one or more additional weights on the mount. In the embodiment shown, the automatic welding machine comprises a mount arranged on a top side of the automatic welding machine 1 in the form of a mounting plate 42, on which additional weights 50 can be placed as required in order to increase a contact pressure of the pressure roller 21 on the material sheets to be joined.

In other words, on the automatic welding machine 1 in a region or a mount 40 where the additional weights 50 can be mounted a weight sensor 41 is installed, which measures the weight force between the additional weight(s) and the automatic welding machine 1 or a frame of the automatic welding machine.

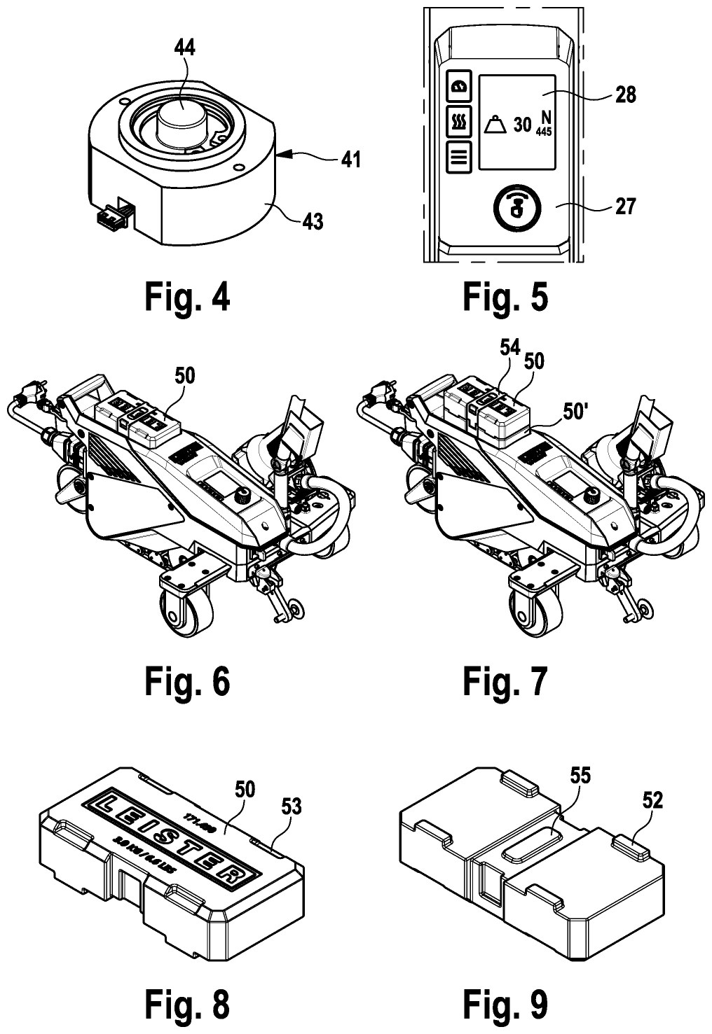

An exemplary weight sensor 41 is illustrated in FIG. 4. Preferably, commercially available weight sensors 41 can herby be used. Thereby, it can be a weight sensor in the form of a compression load cell, with a force intake 44, which transmits the force to a sensor integrated in a housing 43, which converts or outputs the measured force into an electrical signal. For example, it can be a pressure load cell with a compact design, such as the TFX 29 model from E CONNECTIVITY SENSORS with a height of around 5 mm and a diameter of around 20 mm. Such a weight sensor thus only requires a small installation space.

As shown in FIG. 6 and FIG. 7, the automatic welding machine can comprise several additional weights 50 configured to be stacked on top of each other on the mount 40. For example, a typical additional weight has a mass of 3 kg. As the additional weights can be mounted stacked, the total weight of the additional weights is measured with the weight sensor 41. Based thereon on the one hand the mounted (total) additional weight but on the other hand also the number of mounted (predefined) additional weights can be displayed/measured. Typically, 0-2 additional weights are used. Additional forces on the weight sensor can also be determined, for example if the operator presses manually on the additional weights during welding. In addition, in consideration of the known, permanently installed weight 51, the total contact pressure force can be acquired, which ideally acts via the pressure roller 21 on the weld seam or the connection region. It is to be understood that the permanently installed or fixed weight can be a weight that can be removed to facilitate transport. For example, it can be a bolted or screwed-in weight with a mass of approximately 22 kg. In the embodiment shown, in which only the additional weights are measured, the permanently installed weight can for example be taken into account as an offset.

FIG. 8 shows a perspective illustration from diagonally upward of an additional weight 50. FIG. 9 shows a perspective view of the additional weight 50 of FIG. 8 from diagonally below. As already described at the beginning, the additional weight can comprise a raised contact surface 55, which is configured to contact the weight sensor 41 in the mount 40 and to exert a weight force on the weight sensor 41. Furthermore, corresponding protrusions 52 and recesses 53 can be provided on a bottom side and a top side of the additional weights 50. Thereby the additional weights can be stacked on top of each other in a simple and stable manner. Optionally, a holder 54 can also be provided, as shown in FIG. 7, in order to additionally secure the additional weights on the automatic welding machine 1.

In the embodiments described above, the weight sensor 41 is provided in the mount 40 for the one or more additional weights 50. It is to be understood that this actually measures the weight force acting between the additional weights 50 and the mount 40 and not directly the weight force transferred from the pressure roller to the ground. During regular operation, however, the additional weight force by the additional weights also acts on the pressure roller. In other words, an actual contact pressure force between the pressure roller and the welding material is not necessarily recorded directly, but only the force between the additional weights and the machine is measured. If, for example, the pressure roller 21 is slightly relieved with the guide rod 30, for example during direction corrections, this would not be recorded.

Alternatively or additionally, a weight sensor can therefore be provided, which is configured to measure a weight force between the chassis 20 of the automatic welding machine and ground. For example, an integrated force sensor can be provided, which is integrated into the (elastic) contact surface of the pressure roller in order to reliably measure the actual force or the contact pressure between the pressure roller and the welding material on the ground, for example as a co-rotating sensor band, in particular over the entire circumference of the roller, and/or over the entire width of the roller or with several narrow bands distributed over the width of the roller in order to be able to also measure the pressure distribution over the width of the roller. In FIG. 10, such an embodiment is designated with reference sign 41′. Alternatively or additionally, the weight sensor for measuring a weight force caused by the one or more additional weights 50 in the mount 40, which acts at least partially on the pressure roller 21, can also be implemented with a weight sensor on an axle 46 and/or on a bearing, such as a rocker of the chassis 20 of the automatic welding machine 1 carrying the pressure roller.

In the following, aspects of an advantageous controller or control unit 27 are described. The control units described in the context of the present disclosure can be separate control units. However, one or more of the functions mentioned can also be implemented by a common control unit or a combination of control units. Preferably, the control unit is implemented in the form of a circuit with one or more microprocessors or microcontrollers in the automatic welding machine.

FIG. 5 shows an exemplary top view of a control unit 27 and display 28 of an automatic welding machine. In the example shown, the display shows a weight force of 30 N (Newton) detected by the weight sensor 41. This corresponds approximately to a single additional weight of 3 kg mass. In addition, a weight force caused by the own weight of the automatic welding machine, in particular a proportion of the own weight of the automatic welding machine acting on the pressure roller, can be displayed, in the present example 445 N. Hereby, the weight force of a permanently installed weight can be taken into account, for example, as a fixed value that may be predetermined during manufacturing. In other words, a display device 28 can be configured to display an additional weight and/or a weight force of the pressure roller on ground based on the weight force measured by the weight sensor 41. However, it is also possible that the display device 28 is configured to display one or more predefined values, in particular a number, of predefined additional weights 50 based on the weight force measured by the weight sensor 41. In particular, a simplified display, on which only a number of the attached additional weights is displayed, can facilitate operation. Optionally, the display can also be configured to display a target value of a number of additional weights to be applied and/or a target value of a mass to be applied or a weight force caused by the additional weight. Thereby the so-called recipes to be carried out for the respective welding task can be shown to an operator in a simple way.

As described above, the control unit can be configured to set one or more welding parameters based on the weight force measured by the weight sensor 41. If the automatic welding machine comprises a drive as shown in the present non-limiting example, the control unit 27 can be configured to set a drive speed of the drive based on the weight force measured by the weight sensor 41. Alternatively or additionally, the control unit 27 can be configured to set a heating power of the heating device 10 based on the weight force measured by the weight sensor 41. If the heating device 10 comprises a hot air blower, the control unit 27 can be configured to set an air volume based on the weight force measured by the weight sensor 41. The control unit 27 can be configured to display one or more of (a) a mains voltage, (b) a movement speed, (c) a hot air temperature, (d) a heating wedge temperature (e) a speed of a hot air blower on a display and/or to record it over time.

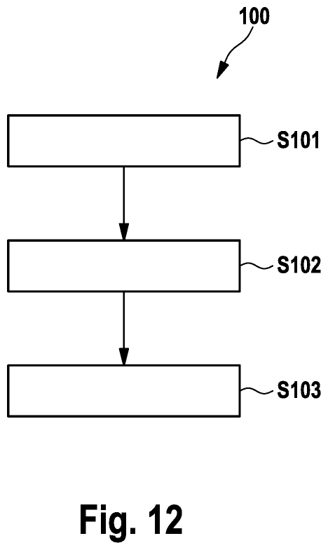

FIG. 12 shows a flowchart 100 of a method for thermally joining material sheets, in particular for edge-side joining of an overlapping upper material sheet with a lower material sheet, which can be connected to one another in a materially bonded manner under the application of heat and subsequent application of pressure. In a first step S101, an automatic welding machine as described in the context of the present disclosure is provided. In a second step S102, one or more additional weights, which are configured to increase a pressure on the pressure roller, are applied in the mount of the automatic welding machine. In a third step S103, a weight force caused by the one or more additional weights, which acts at least partially on the pressure roller, is measured. In one or more optional subsequent steps, the measured weight force can optionally be displayed on a display device, stored for documentation purposes or used to adjust one or more welding parameters.

In summary, with the solutions provided herein an improved automatic welding machine for the thermal joining of material sheets can be provided, in particular for the edge-side joining of an overlapping upper material sheet with a lower material sheet, which can be connected to one another in a materially bonded manner under the application of heat and subsequent application of pressure. The proposed solution allows that in ground-level automatic welding machines the mounted additional weight can be electronically detected or measured, so that the (theoretical) contact pressure in the region of the pressure roller can be acquired and for example be shown on a display or used for adjustment of welding parameters.

It is to be understood that the foregoing description is of one or more embodiments of the invention. The invention is not limited to the particular embodiment(s) disclosed herein, but rather is defined solely by the claims below. Furthermore, the statements contained in the foregoing description relate to the disclosed embodiment(s) and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art.

As used in this specification and claims, the terms “e.g.,” “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation. In addition, the term “and/or” is to be construed as an inclusive OR. Therefore, for example, the phrase “A, B, and/or C” is to be interpreted as covering all of the following: “A”; “B”; “C”; “A and B”; “A and C”; “B and C”; and “A, B, and C.”

What is claimed is:

1. An automatic welding machine for thermal joining of material sheets, in particular for edge-side joining of an overlapping upper material sheet to a lower material sheet, to be connected to one another in a materially bonded manner under the application of heat and subsequent application of pressure, comprising
a heating device for at least partially heating the material sheets to be joined in a connection region;
a chassis comprising a pressure roller configured to apply pressure to the material sheets in the working direction behind the heating device;
a mount for one or more additional weights configured to increase a pressure on the pressure roller; and
a weight sensor for measuring a weight force caused inter alia by the one or more additional weights in the mount, which acts at least partially on the pressure roller.

2. The automatic welding machine according to claim 1, wherein the weight sensor is arranged in the mount for the one or more additional weights, and wherein the weight sensor is configured to measure a weight force exerted by the one or more additional weights on the mount.

3. The automatic welding machine according to claim 2, wherein the chassis comprises a mounting plate for the one or more additional weights and the weight sensor is arranged in the mounting plate.

4. The automatic welding machine according to claim 3, wherein the mounting plate is arranged above the pressure roller.

5. The automatic welding machine according to claim 1, wherein the automatic welding machine comprises a plurality of additional weights configured to be stacked on top of each other on the mount.

6. The automatic welding machine according to claim 3, wherein at least one of the additional weights comprises a raised contact surface and is configured to contact the weight sensor in the mount and to exert a weight force on the weight sensor.

7. The automatic welding machine according to claim 1, wherein the weight sensor is configured to measure a weight force between the chassis of the automatic welding machine and ground.

8. The automatic welding machine according to claim 1, comprising a control unit, wherein the control unit is configured to set a welding parameter based on the weight force measured by the weight sensor.

9. The automatic welding machine according to claim 8, wherein the automatic welding machine comprises a drive, and wherein the control unit is configured to set a drive speed of the drive based on the weight force measured by the weight sensor.

10. The automatic welding machine according to claim 8, wherein the control unit is configured to adjust a heating power of the heating device based on the weight force measured by the weight sensor.

11. The automatic welding machine according to claim 8, wherein the heating device comprises a hot air blower, and wherein the control unit is arranged to adjust an air flow based on the weight force measured by the weight sensor.

12. The automatic welding machine according to claim 1, wherein the automatic welding machine further comprises a display device for displaying an additional weight and/or a weight force of the pressure roller on ground based on the weight force measured by the weight sensor.

13. The automatic welding machine according to claim 12, wherein the automatic welding machine is configured to display one or more predefined values of predefined additional weights based on the weight force measured by the weight sensor.

14. The automatic welding machine according to claim 13, wherein the automatic welding machine is configured to display a number of predefined additional weights based on the weight force measured by the weight sensor.

15. The automatic welding machine according to claim 1, comprising a control unit adapted to detect a presence and/or values of the one or more additional weights in the mount over time, based on the weight force measured by the weight sensor.

16. The automatic welding machine according to claim 1, comprising a control unit configured to determine a total weight force based on a known weight of the automatic welding machine without additional weight and further based on the weight force measured by the weight sensor.

17. The automatic welding machine according to claim 1, comprising a control unit configured to determine a total weight force acting on the pressure roller based on a known weight of the automatic welding machine without additional weight and further based on the weight force measured by the weight sensor.

18. The automatic welding machine according to claim 1, wherein the heating device comprises an electrically heated welding wedge and/or a hot air blower.

19. The automatic welding machine according to claim 1, comprising a control unit configured to display one or more of (a) a mains voltage, (b) a movement speed, (c) a hot air temperature, (d) a heating wedge temperature, (e) a speed of a hot air blower on a display device and/or to record it over time.

20. A method for thermal joining of material sheets, in particular for edge-side joining of an overlapping upper material sheet to a lower material sheet, to be connected to one another in a materially bonded manner under the application of heat and subsequent application of pressure, comprising the steps of:
providing an automatic welding machine according to claim 1;
applying one or more additional weights, which are configured to increase a pressure on the pressure roller, on the mount of the automatic welding machine; and
measuring a weight force caused inter alia by the one or more additional weights, which acts at least partially on the pressure roller.

21. The automatic welding machine according to claim 4, wherein at least one of the additional weights comprises a raised contact surface and is configured to contact the weight sensor in the mount and to exert a weight force on the weight sensor.
